(19) United States
(12) Patent Application Publication
(10) Pub. No.: US 2026/0208512 A1
(43) Pub. Date: Jul. 23, 2026

(54) RECORDING APPARATUS AND EXTENSION BODY

(71) Applicant: SEIKO EPSON CORPORATION, Tokyo (JP)

(72) Inventors: Soma KAWADA, MATSUMOTO-SHI (JP); Dai KUTSUKAWA, HOKUTO-SHI (JP)

(21) Appl. No.: 19/455,079

(22) Filed: Jan. 21, 2026

(30) Foreign Application Priority Data
Jan. 22, 2025 (JP) 2025-008986

(51) Int. Cl. B41J 13/10; B41J 13/03; B41J 29/13

(52) U.S. Cl. CPC B41J 13/103; B41J 13/03; B41J 29/13

(57) ABSTRACT

A recording apparatus includes a main body unit including a recording unit configured to perform recording on a medium, a cassette detachably provided in the main body unit, the cassette including a storing unit configured to store the medium, and a delivery roller configured to deliver the medium from the storing unit. A driving roller located below the delivery roller is provided in the cassette, the driving roller conveying, toward the recording unit, the medium delivered from another cassette provided below the cassette.

The present application is based on, and claims priority from JP Application Serial Number 2025-008986, filed January 22, 2025, the disclosure of which is hereby incorporated by reference herein in its entirety.

### BACKGROUND

### 1. Technical Field

The present disclosure relates to a recording apparatus and an extension body.

### 2. Related Art

JP-A-2006-056657 discloses an image forming apparatus including an image forming apparatus main body and an additional paper feeding device detachably attachable to a lower part of the image forming apparatus main body. The image forming apparatus main body includes a first paper feeding cassette including an image forming unit and a recording paper storage unit and a paper feeding mechanism that separates and feeds pieces of recording paper stored in the recording paper storage unit one by one. The additional paper feeding device includes a second paper feeding cassette including a recording paper storage unit and a paper feeding mechanism that separates and feeds pieces of recording paper stored in the recording paper storage unit one by one. A conveyance roller pair that conveys the recording paper from the additional paper feeding device located below to the image forming apparatus main body is provided in the additional paper feeding device.

JP-A-2006-056657 is an example of the related art.

However, in the image forming apparatus disclosed in JP-A-2006-056657, it is likely that the dimension in the height direction of the additional paper feeding device increases because of the conveyance roller pair that conveys the recording paper, which is fed from the additional paper feeding device located below, to the image forming apparatus main body.

### SUMMARY

According to an aspect of the present disclosure, there is provided a recording apparatus including: a main body unit including a recording unit configured to perform recording on a medium; a cassette detachably provided in the main body unit, the cassette including a storing unit configured to store the medium; and a delivery roller configured to deliver the medium from the storing unit, wherein a conveyance roller located below the delivery roller is provided in the cassette, the conveyance roller conveying, toward the recording unit, the medium delivered from another cassette provided below the cassette.

According to another aspect of the present disclosure, there is provided an extension body attachable to a main body unit including a recording unit configured to perform recording on a medium, the extension body including: a cassette detachably provided in the extension body, the cassette including a storing unit configured to store the medium; and a delivery roller configured to deliver the medium from the storing unit, wherein a conveyance roller located below the delivery roller is provided in the cassette, the conveyance roller conveying, toward the recording unit, the medium delivered from another cassette provided below the cassette.

### BRIEF DESCRIPTION OF THE DRAWINGS

FIG. 1 is a perspective view of a recording apparatus according to an embodiment.

FIG. 2 is a schematic configuration diagram in which a recording apparatus to which an extension body is attached is viewed from a side.

FIG. 3 is a schematic configuration diagram in which the recording apparatus is viewed from a side.

FIG. 4 is a schematic configuration diagram in which the extension body is viewed from a side.

FIG. 5 is a schematic configuration diagram in which the extension body is viewed from a side.

### DESCRIPTION OF EMBODIMENTS

Hereinafter, the present disclosure is explained based on an embodiment. In the figures, the same members are denoted by the same reference numerals and signs and redundant explanation is sometimes omitted. The terms "same", "identical", and "simultaneous" described in the present specification do not indicate only being completely the same.

For example, the terms "same", "identical", and "simultaneous" described in the present specification mean being the same when measurement errors are considered. For example, the terms "same", "identical", and "simultaneous" described in the present specification mean being the same considering manufacturing variations of members.

For example, the terms "same", "identical", and "simultaneous" described in the present specification mean being the same in a range in which functions are not spoiled. Therefore, for example, "both dimensions are the same" indicates that the difference between both the dimensions is ±5% or less, particularly, preferably ±3% or less of one dimension when measurement errors and manufacturing variations of members are considered.

In the figures, X, Y, and Z represent three spatial axes orthogonal to one another. In the present specification, directions along these axes are represented as an X-axis direction, a Y-axis direction, and a Z-axis direction. When directions are specified, a positive direction is represented as "+" and a negative direction is represented as "-", the positive and negative signs are used together for direction, and a direction pointed by an arrow is described as a + direction and the direction opposite to the direction pointed by the arrow is described as a - direction in the figures.

The Z-axis direction indicates the direction of gravity, the +Z direction indicates a vertically upward direction, and the -Z direction indicates a vertically downward direction. A plane including an X axis and a Y axis is described as an X-Y plane, a plane including the X axis and a Z axis is described as an X-Z plane, and a plane including the Y axis and the Z axis is described as a Y-Z plane. The X-Y plane is a horizontal plane. The three spatial axes X, Y, and Z, which do not limit the positive direction and the negative direction, are described as the X axis, the Y axis, and the Z axis.

The X-axis direction is a horizontal direction along an installation surface, which is the horizontal surface, on which a recording apparatus 1 is installed. The X- axis direction is the width direction of the recording apparatus 1 and is the width direction of a medium P on which recording is performed. The Y-axis direction is the horizontal direction along the installation surface on which the recording apparatus 1 is installed. The Y-axis direction is a depth direction of the recording apparatus 1 and is a direction along a conveyance direction of the medium P at the time of recording.

The +Y direction is a direction from the back surface to the front surface of the recording apparatus 1 and the -Y direction is a direction from the front surface to the back surface of the recording apparatus 1. In the present embodiment, among the side surfaces forming the periphery of the printing apparatus 1, the side surface in the +Y direction is the front surface of the printing apparatus 1 and the side surface in the -Y direction is the back surface of the printing apparatus 1.

The side surface in the +X direction is the left side surface of the recording apparatus 1 and the side surface in the -X direction is the right side surface of the recording apparatus 1. The Z-axis direction is the normal direction with respect to the installation surface on which the recording apparatus 1 is installed and is the height direction of the recording apparatus 1.

In the following explanation, the direction in which the medium P is sent is sometimes referred to as "downstream" and the direction opposite to the direction is sometimes referred to as "upstream". For convenience of illustration, the sizes of members are sometimes different from actual sizes.

### Embodiment

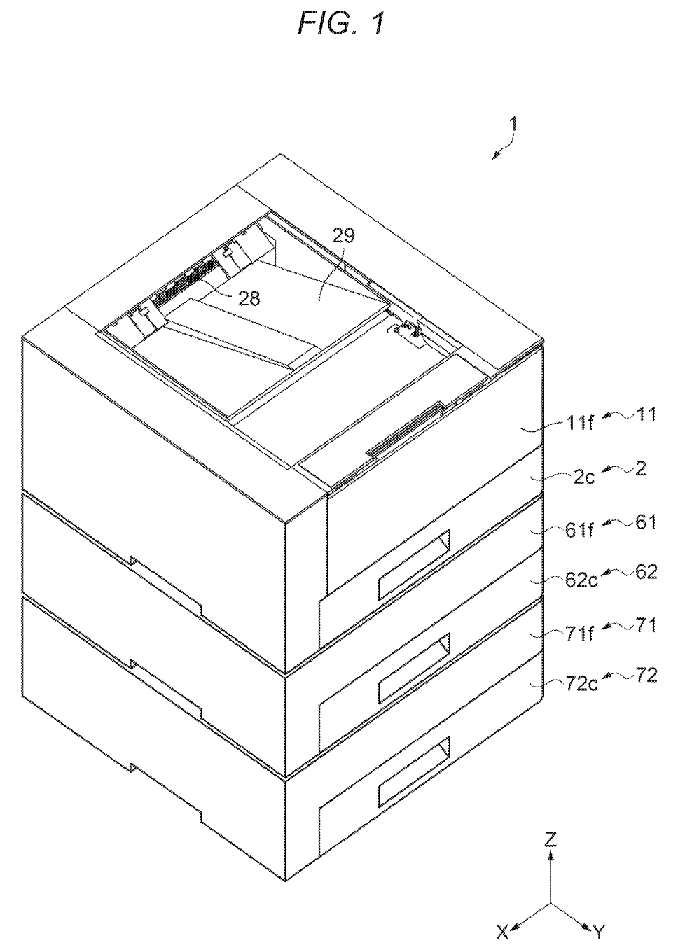

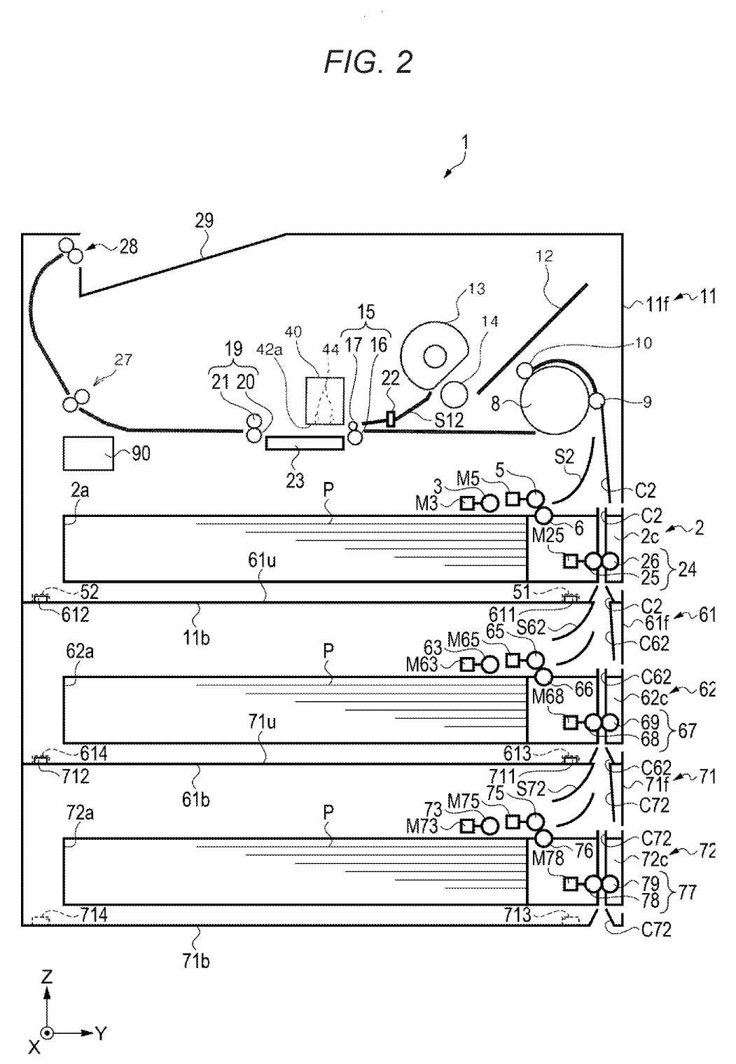

A schematic configuration of the recording apparatus 1 according to an embodiment is explained along a conveyance path on which the medium P is conveyed. As illustrated in FIGS. 1 and 2, the recording apparatus 1 includes a main body unit 11 including a recording unit 40 (see FIG. 2) that performs recording on the medium P. The recording apparatus 1 includes a cassette 2 on a bottom surface 1 lb side that is the-Z direction from the center of the main body unit 11.

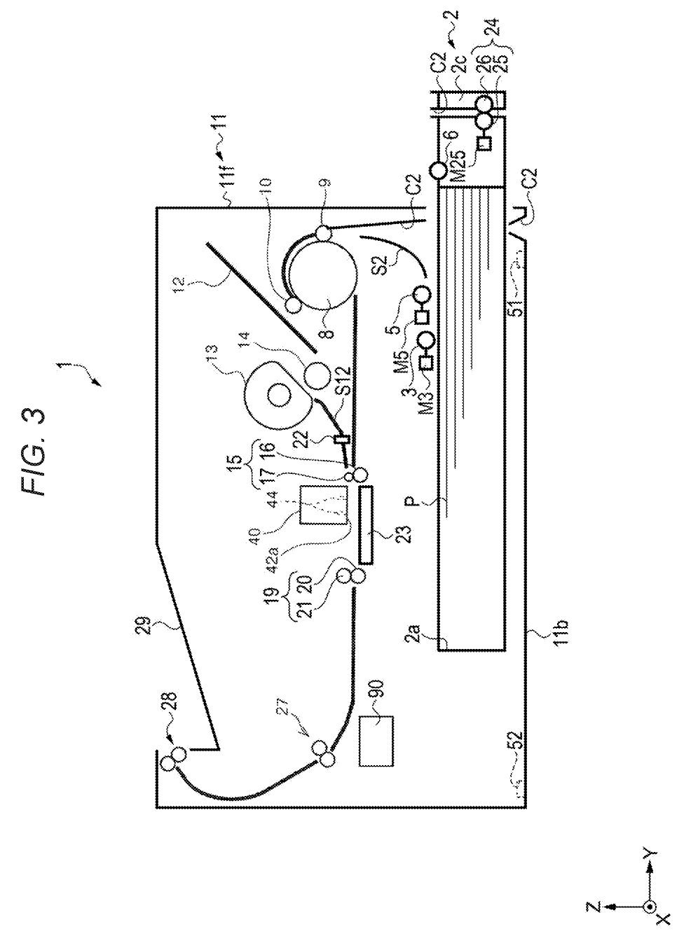

As illustrated in FIGS. 2 and 3, the cassette 2 is provided in the main body unit 11 to be detachable from a side surface 11f side, which is a side surface on the +Y direction side of the main body unit 11. In the present embodiment, the side surface 11f is the front surface of the main body unit 11. The cassette 2 includes a storing unit 2a and a cover 2c. Media P are stored in the storing unit 2a. As illustrated in FIGS. 1 and 2, the cover 2c is disposed on the side surface 11f side of the main body unit 11, which is in the +Y direction of the storing unit 2a, and configures a part of the outer shell of the main body unit 11.

As illustrated in FIG. 2, a delivery roller 3 driven by a motor M3 is provided above the storing unit 2a of the cassette 2. The delivery roller 3 is capable of advancing and retracting with respect to the medium P stored in the storing unit 2a. The delivery roller 3 rotates in contact with the medium P stored in the storing unit 2a to deliver the medium P from the storing unit 2a of the cassette 2 in the +Y direction.

In the main body unit 11, a feeding roller 5 driven by a motor M5 and a separation roller 6 to which rotational torque is applied by a not-illustrated torque limiter are provided at a position downstream of the delivery roller 3.

The separation roller 6 in the present embodiment is provided on the cover 2c of the cassette 2. The medium P delivered from the storing unit 2a is separated by being nipped by the feeding roller 5 and the separation roller 6 and is further sent downstream.

A reversing roller 8 driven by a not-illustrated motor is provided downstream of the feeding roller 5 and the separation roller 6. A first nip roller 9 and a second nip roller 10 are provided around the reversing roller 8.

The medium P is nipped by the reversing roller 8 and the first nip roller 9, further nipped by the reversing roller 8 and the second nip roller 10, and conveyed. A conveyance direction of the medium P is reversed from the +Y direction to the -Y direction by the reversing roller 8 and the medium P is conveyed downstream.

A first conveyance roller pair 15 including a driving roller 16 driven by a not- illustrated motor and a driven roller 17 capable of rotating following the driving roller 16 is provided downstream of the reversing roller 8. The medium P is conveyed to, by the first conveyance roller pair 15, a position facing the recording unit 40.

The recording apparatus 1 includes a feeding path S12 from a medium support unit 12 and a feeding path C2 from a cassette 62 in addition to a feeding path S2 from the cassette 2. The feeding path S12 merges with, at a position upstream of the first conveyance roller pair 15, a conveyance path from the reversing roller 8 toward the recording unit 40.

The recording apparatus 1 includes, in the main body unit 11, the medium support unit 12 on which a user can place the medium P. The medium support unit 12 supports the medium P in an inclined posture. The medium P supported by the medium support unit 12 is conveyed toward the first conveyance roller pair 15 via the feeding path S12 by a feeding roller 13 driven by a not-illustrated motor. Rotational torque is applied to a separation roller 14 by a not-illustrated torque limiter.

The feeding path C2 is a path on which the medium P delivered from the cassette 62 located below the cassette 2 is conveyed toward the recording unit 40. The feeding path C2 is provided on the +Y direction side of the storing unit 2a and extends upward, which is the +Z direction, from the bottom surface 1lb. For this reason, at least a part of the feeding path C2 is provided on the cover 2c of the cassette 2.

A relay roller pair 24 including a driving roller 25 driven by a motor M25 and a driven roller 26 capable of rotating following the driving roller 25 is provided in the feeding path C2. For this reason, the relay roller pair 24 and the motor M25 are provided on the cover 2c of the cassette 2.

The relay roller pair 24 is located below the delivery roller 3 and the feeding roller 5. The relay roller pair 24 is provided at a position overlapping the storing unit 2a when viewed from the +Y direction side, which is the side surface 1 if side of the main body unit 11.

The medium P conveyed from the cassette 62 is conveyed toward the recording unit 40 via the feeding path C2 by the relay roller pair 24. The driving roller 25 of the relay roller pair 24 is an example of a conveyance roller that conveys, toward the recording unit 40, the medium P conveyed from below.

A medium detection unit 22 is provided upstream of the first conveyance roller pair 15. A control unit 90 explained below can position the leading end of the medium P with respect to the recording unit 40 based on detection information of the medium detection unit 22. For example, the control unit 90 can position the medium P at a recording start position.

The recording unit 40 performs recording by ejecting ink onto the medium P from a plurality of nozzles 44 provided on an ejection surface 42a. The ink is an example of liquid. The recording unit 40 is a so-called line head in which the plurality of nozzles 44 that eject the ink are arrayed to cover the entire region in the medium width direction. The recording unit 40 is long in the medium width direction and is configured as a liquid ejection head capable of performing recording on the entire medium width region without involving movement in the medium width direction.

The ejection surface 42a is a surface facing the medium P. The ejection surface 42a can also be referred to as a liquid ejection surface or a nozzle surface. The printing apparatus 1 includes a not-illustrated liquid storing unit. The ink to be ejected from the recording unit 40 is supplied from the liquid storing unit to the recording unit 40 via a not-illustrated supply tube.

A facing unit 23 is provided at a position facing the ejection surface 42a of the recording unit 40. The facing unit 23 supports the medium P. When the facing unit 23 supports the medium P, a gap between the medium P and the ejection surface 42a is specified.

A second conveyance roller pair 19 is provided downstream of the recording unit 40. The second conveyance roller pair 19 includes a driving roller 20 driven by a not-illustrated motor and a driven roller 21 capable of rotating following the driving roller 20. The medium P on which recording has been performed is sent downstream by the second conveyance roller pair 19.

A third conveyance roller pair 27 is provided downstream of the second conveyance roller pair 19. A discharge roller pair 28 is further provided downstream of the third conveyance roller pair 27. A path between the third conveyance roller pair 27 and the discharge roller pair 28 configures a face-down discharge path. The medium P on which recording has been performed is discharged to the discharge tray 29 by the discharge roller pair 28 in a state in which a most recent recording surface faces down.

In the recording apparatus 1, an extension body 61 is detachably attachable to a position below the bottom surface 1 lb of the main body unit 11. The extension body 61 includes the cassette 62. The cassette 62 is an example of another cassette provided below the cassette 2.

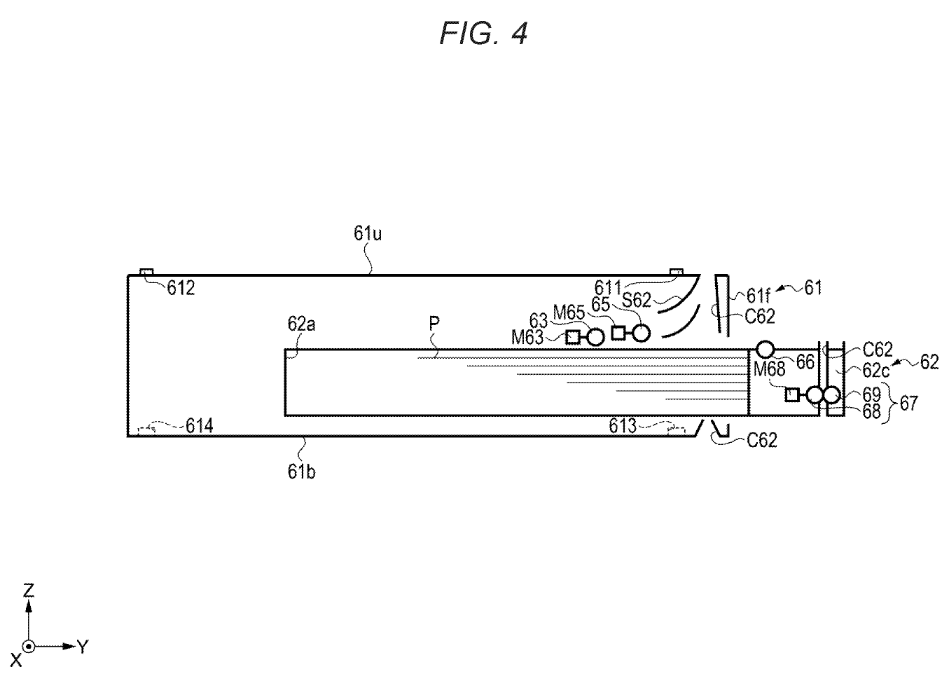

The cassette 62 is provided in the extension body 61 detachably attachable from a side surface 61f side, which is a side surface on the +Y direction side of the extension body 61 (see FIG. 4). In the present embodiment, the side surface 61f is the front surface of the extension body 61. When the extension body 61 is attached to the main body unit 11, the recording apparatus 1 includes a plurality of cassettes 2 and 62 that stores the media P.

The cassette 62 includes an storing unit 62a and a cover 62c. The media P are stored in the storing unit 62a. The cover 62c is disposed on the side surface 61f side of the extension body 61, which is the +Y direction of the storing unit 62a, and configures a part of the outer shell of the extension body 61.

In the extension body 61, a delivery roller 63 driven by a motor M63 is provided at a position above the storing unit 62a. The delivery roller 63 is capable of advancing and retracting with respect to the medium P stored in the storing unit 62a. The delivery roller 63 rotates in contact with the medium P stored in the storing unit 62a to deliver the medium P in the +Y direction from the storing unit 62a of the cassette 62.

The medium P delivered from the storing unit 62a is conveyed to the feeding path C2 via a feeding path S62 provided in the extension body 61. In the extension body 61, a feeding roller 65 driven by a motor M65 and a separation roller 66 to which rotational torque is applied by a not-illustrated torque limiter are provided at a position, which is downstream of the delivery roller 63.

The separation roller 66 in the present embodiment is provided on the cover 62c of the cassette 62. The medium P delivered from the storing unit 62a is separated by being nipped by the feeding roller 65 and the separation roller 66 and is sent downstream on the feeding path S62.

In addition to the feeding path S62, the extension body 61 includes a feeding path C62 on which the medium P delivered from an extension body 71 explained below is conveyed. The feeding path C62 is, for example, a path on which the medium P delivered from a cassette 72 located below the cassette 62 is conveyed toward the recording unit 40.

The feeding path C62 is provided on the +Y direction side of the storing unit 62a and extends upward, which is the +Z direction, from a bottom surface 61b of the extension body 61. For this reason, at least a part of the feeding path C62 is provided in the cover 62c of the cassette 62.

A relay roller pair 67 including a driving roller 68 driven by a motor M68 and a driven roller 69 capable of rotating following the driving roller 68 is provided in the feeding path C62. For this reason, the relay roller pair 67 and the motor M68 are provided on the cover 62c of the cassette 62.

The relay roller pair 67 is located below the delivery roller 63 and the feeding roller 65. The relay roller pair 67 is provided at a position overlapping the storing unit 62a when viewed from the +Y direction side. The medium P conveyed from the extension body 71 including the medium P conveyed from a storing unit 72a of the cassette 72 is conveyed toward the recording unit 40 via the feeding path C62 by the relay roller pair 67. The driving roller 68 of the relay roller pair 67 is an example of a conveyance roller that conveys, toward the recording unit 40, the medium P conveyed from below.

When being attached the main body unit 11, the extension body 61 is attached to the bottom surface 1lb of the main body unit 11. The bottom surface 1lb of the main body unit 11 is an example of an attachment section to which the extension body 61 is attached. Attachment sections 51 and 52 for attaching the extension body 61 to the main body unit 11 are provided on the bottom surface 1lb.

Sections to be attached 611 and 612 to be fit in the attachment sections 51 and 52 are provided on an upper surface 61u of the extension body 61. The attachment section 51 and the section to be attached 611 are provided at, for example, positions adjacent to the -Y direction side of the feeding path C62 and the relay roller pair 67 in the Y-axis direction. The attachment section 52 and the section to be attached 612 are provided at positions separated from the attachment section 51 and the section to be attached 611 in the -Y direction.

The attachment section 51 is, for example, a circular recess provided on the bottom surface 1lb. The attachment section 52 is, for example, a track-shaped recess long in the Y-axis direction provided on the bottom surface 1lb. The sections to be attached 611 and 612 are, for example, cylindrical protrusions projecting from the upper surface 61u of the extension body 61.

When the section to be attached 611 is fit in the attachment section 51, the position of the extension body 61 with respect to the attachment section 51 is specified. Further, when the section to be attached 612 is fit in the attachment section 52, the position of the extension body 61 with respect to the bottom surface l1b is specified.

When the extension body 61 is attached to the main body unit 11, the motors M63, M65, and M68 of the extension body 61, a sensor (not illustrated) that detects the presence or absence of the medium P, and the like are electrically coupled to the control unit 90 via a not-illustrated electrical coupling section for the main body unit 11 and the extension body 61.

The extension body 71 is detachably attachable to the extension body 61 at a position below the bottom surface 61b. The extension body 71 includes the cassette 72. The cassette 72 is an example of another cassette provided below the cassette 2.

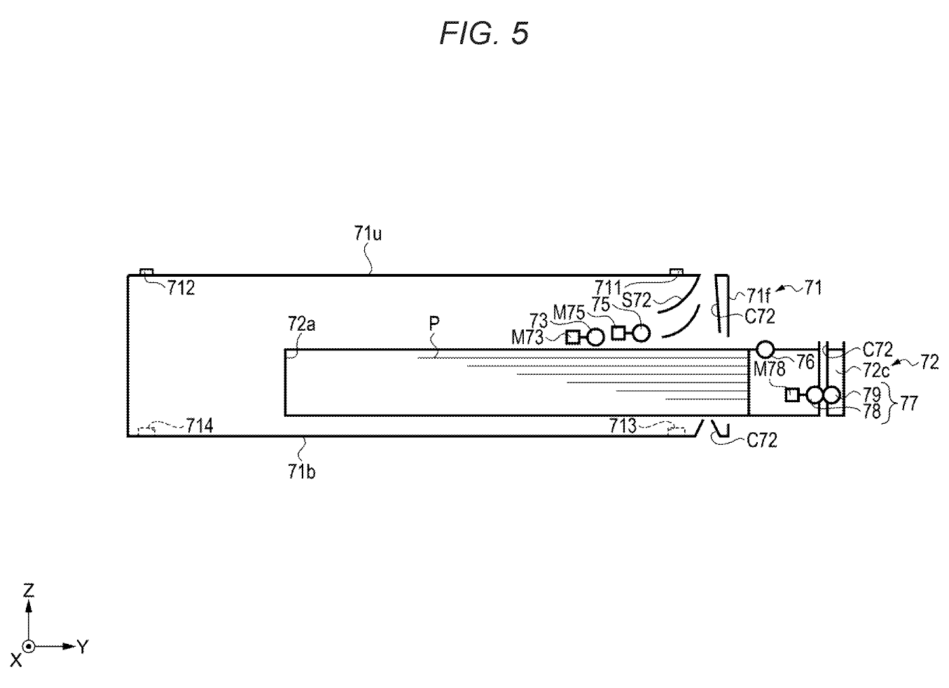

The cassette 72 is provided in the extension body 71 detachably attachable from a side surface 71f side, which is a side surface on the +Y direction side of the extension body 71 (see FIG. 5). In the present embodiment, the side surface 71f is the front surface of the extension body 71. When the extension body 71 is attached to the extension body 61, the recording apparatus 1 includes a plurality of cassettes 2, 62, and 72 that store the media P.

The cassette 72 includes the storing unit 72a and a cover 72c. The media P are stored in the storing unit 72a. The cover 72c is disposed on the side surface 71f side of the extension body 71, which is the +Y direction of the storing unit 72a, and configures a part of the outer shell of the extension body 71.

In the extension body 71, a delivery roller 73 driven by a motor M73 is provided at a position, which is above the storing unit 72a of the cassette 72. The delivery roller 73 is capable of advancing and retracting with respect to the medium P stored in the storing unit 72a. The delivery roller 73 rotates in contact with the medium P stored in the storing unit 72a to deliver the medium P in the +Y direction from the storing unit 72a of the cassette 72.

The medium P delivered from the storing unit 72a is conveyed to the feeding path C62 of the extension body 61 via a feeding path S72 provided in the extension body 71. In the extension body 71, a feeding roller 75 driven by a motor M75 and a separation roller 76 to which rotational torque is applied by a not-illustrated torque limiter are provided at a position, which is downstream of the delivery roller 73.

The separation roller 76 in the present embodiment is provided on the cover 72c of the cassette 72. The medium P delivered from the storing unit 72a is separated by being nipped by the feeding roller 75 and the separation roller 76 and is sent downstream on the feeding path S72.

The extension body 71 includes a feeding path C72 in addition to the feeding path S72. The feeding path C72 is a path on which the medium P conveyed from below the cassette 72 is conveyed toward the recording unit 40.

The feeding path C72 is provided on the +Y direction side of the storing unit 72a and extends upward, which is the +Z direction, from a bottom surface 71b of the extension body 71. For this reason, at least a part of the feeding path C72 is provided on the cover 72c of the cassette 72.

A relay roller pair 77 including a driving roller 78 driven by a motor M78 and a driven roller 79 capable of rotating following the driving motor 78 is provided in the feeding path C72. The relay roller pair 77 and the motor M78 are provided on the cover 72c of the cassette 72.

The relay roller pair 77 is located below the delivery roller 73 and the feeding roller 75. The relay roller pair 77 is provided at a position overlapping the storing unit 72a when viewed from the +Y direction side. The medium P conveyed from below the cassette 72 is conveyed toward the recording unit 40 via the feeding path C72 by the relay roller pair 77. The driving roller 78 of the relay roller pair 77 is an example of a conveyance roller that conveys, toward the recording unit 40, the medium P conveyed from below.

When being attached to the extension body 61, the extension body 71 is attached to the bottom surface 61b of the extension body 61. The bottom surface 61b of the extension body 61 is an example of an attachment section to which the extension body 71 is attached. Attachment sections 613 and 614 for attaching the extension body 71 to the extension body 61 are provided on the bottom surface 61b.

Sections to be attached 711 and 712 to be fit in the attachment sections 613 and 614 are provided on an upper surface 71u of the extension body 71. The attachment section 613 and the section to be attached 711 are provided at, for example, positions adjacent to the -Y direction side of the feeding path C72 and the relay roller pair 77 in the Y-axis direction. The attachment section 614 and the section to be attached 712 are provided at positions separated from the attachment section 613 and the section to be attached 711 in the -Y direction.

The attachment section 613 is, for example, a circular recess provided on the bottom surface 61b. The attachment section 614 is, for example, a track-shaped recess long in the Y-axis direction provided on the bottom surface 61b. The sections to be attached 711 and 712 are, for example, cylindrical protrusions projecting from the upper surface 71u of the extension body 71.

The attachment section 613 in the present embodiment has the same shape as the shape of the attachment section 51 of the main body unit 11 and is provided at the same position as the position of the attachment section 51 in the X-axis direction and the Y-axis direction. The attachment section 614 in the present embodiment has the same shape as the shape of the attachment section 52 of the main body unit 11 and is provided at the same position as the position of the attachment section 52 in the X-axis direction and the Y-axis direction.

The sections to be attached 711 and 712 in the present embodiment have the same shape as the shape of the sections to be attached 611 and 612 of the extension body 61. The section to be attached 711 in the present embodiment is provided at the same position as the position of the section to be attached 611 in the X-axis direction and the Y-axis direction. The section to be attached 712 in the present embodiment is provided at the same position as the position of the section to be attached 612 in the X-axis direction and the Y-axis direction.

When the section to be attached 711 is fit in the attachment section 613, the position of the extension body 71 with respect to the attachment section 613 is specified. Further, when the section to be attached 712 is fit in the attachment section 614, the position of the extension body 71 with respect to the bottom surface 61b is specified.

When the extension body 71 is attached to the extension body 61, the motors M73, M75, and M78 of the extension body 71, a sensor (not illustrated) that detects the presence or absence of the medium P, and the like are electrically coupled to the control unit 90. At this time, the motors M73, M75, and M78, the sensor, and the like are electrically coupled to the control unit 90 via a not-illustrated electrical coupling section for the extension body 61 and the extension body 71 and a not-illustrated electrical coupling section for the main body unit 11 and the extension body 61.

Attachment sections 713 and 714 are provided on the bottom surface 71b of the extension body 71. The attachment section 713 in the present embodiment has the same shape as the shape of the attachment section 613 of the extension body 61 and the attachment section 51 of the main body unit 11 and is provided at the same position as the position of the attachment sections 51 and 613 in the X-axis direction and the Y-axis direction. The attachment section 714 in the present embodiment has the same shape as the shape of the attachment section 614 of the extension body 61 and the attachment section 52 of the main body unit 11 and is provided at the same position as the position of the attachment sections 52 and 614 in the X-axis direction and the Y-axis direction.

Thus, in the recording apparatus 1 in the present embodiment, the extension body 71 can be attached to the bottom surface 1lb of the main body unit 11 and the extension body 61 can be attached to the bottom surface 71b of the extension body 71.

The recording apparatus 1 includes the control unit 90. Although not illustrated, the control unit 90 includes a CPU (Center Processing Unit). The control unit 90 includes a storage unit including a RAM (Random Access Memory) and a ROM (Read Only Memory). Various programs for controlling the printing apparatus 1 and the extension bodies 61 and 71 explained below are stored in the storage unit.

The control unit 90 may include one or more processors that execute various kinds of processing according to the programs, one or more dedicated hardware circuits such as an application specific integrated circuits ASIC, or a combination of the processors and the dedicated hardware circuits. The application specific integrated circuit ASIC executes at least some kinds of processing among the various kinds of processing.

The processor includes a CPU and memories such as a RAM and a ROM. The memories store program codes or commands configured to cause the CPU to execute processing. The memories, that is, computer-readable media include all media that can be accessed by a general-purpose or dedicated computer.

The control unit 90 in FIGS. 2 and 3 is conceptually illustrated and actually includes a circuit board provided at a predetermined position of the recording apparatus 1. The control unit 90 is electrically coupled to the units provided in the recording apparatus 1 and the extension bodies 61 and 71 and integrally controls the operations of the units.

For example, the control unit 90 controls a conveyance mechanism, which is disposed upstream of the driving roller 16 of the first conveyance roller pair 15, and the driving roller 16. The conveyance mechanism disposed upstream of the driving roller 16 includes the delivery rollers 3, 63, and 73, the feeding rollers 5, 65, and 75, and the driving rollers 25, 68, and 78.

Accordingly, the media P are conveyed from the cassettes 2, 62, and 72 toward the recording unit 40 and the facing unit 23. The control unit 90 controls the recording unit 40 to eject the ink onto the medium P supported by the facing unit 23. Accordingly, an image is recorded on the medium P.

As explained above, with the recording apparatus 1 and the extension body 61 according to the embodiment, effects explained below can be obtained.

The recording apparatus 1 includes the cassette 2 detachably provided in the main body unit 11, the cassette 2 including the storing unit 2a that stores the media P. The recording apparatus 1 includes the delivery roller 3 that delivers the medium P from the storing unit 2a. In the cassette 2, the driving roller 25 located below the delivery roller 3 is provided, the driving roller 25 conveying, toward the recording unit 40, the medium P delivered from the cassette 62 provided below the cassette 2.

Accordingly, it is possible to prevent the dimension in the height direction of the extension body 61, in which the cassette 62 is provided, from increasing. Thus, it is possible to prevent the dimension in the height direction of the recording apparatus 1 from increasing when the extension body 61 is attached to the main body unit 11.

The cassette 62 is detachably provided in the extension body 61 detachably attachable to the main body unit 11. The main body unit 11 includes the bottom surface lb to which the extension body 61 is attached. Accordingly, the extension body 61 can be easily attached to the main body unit 11.

The driving roller 25 is provided at a position overlapping the storing unit 2a when viewed from the +Y direction side of the main body unit 11. Accordingly, it is possible to prevent the dimension in the height direction of the main body unit 11 from increasing because of the disposition of the driving roller 25. Thus, it is possible to prevent the dimension in the height direction of the recording apparatus 1 from increasing.

The motor M25 that drives the driving roller 25 is provided in the cassette 2. Accordingly, the driving roller 25 can be easily driven.

The cassette 2 is detached from the +Y direction side of the main body unit 11. Accordingly, the cassette 2 can be detached from the front surface side of the recording apparatus 1.

The cassette 2 includes the cover 2c on the +Y direction side of the storing unit 2a. The driving roller 25 is provided on the cover 2c. Accordingly, the driving roller 25 can be easily driven.

The medium P is conveyed toward the recording unit 40 through the +Y direction side of the storing unit 2a in the cassette 2. Accordingly, the medium P stored in the storing unit 2a and the medium P conveyed from below the cassette 2 can be efficiently conveyed toward the recording unit 40.

The extension body 61 is detachably attachable to the main body unit 11 including the recording unit 40 that performs recording on the medium P. The extension body 61 includes the cassette 62 detachably provided in the extension body 61, the cassette 62 including the storing unit 62a that stores the media P. The extension body 61 includes the delivery roller 63 that delivers the medium P from the storing unit 62a. In the cassette 62, the driving roller 68 located below the delivery roller 63 is provided, the driving roller 68 conveying, toward the recording unit 40, the medium P delivered from the cassette 72 provided below the cassette 62.

Accordingly, it is possible to prevent the dimension in the height direction of the extension body 61 from increasing.

The recording apparatus 1 according to the embodiment of the present disclosure basically has the configuration explained above. However, it is also naturally possible to make modifications, omissions, and the like of a part of the configuration without departing from the gist of the present disclosure.

The extension bodies 61 and 71 according to the embodiment of the present disclosure basically have the configuration explained above. However, it is also naturally possible to make modifications, omissions, and the like of a part of the configuration without departing from the gist of the present disclosure.

The embodiment and other embodiments explained below can be combined with each other as long as no technical inconsistencies are involved. The other embodiments are explained below.

In the embodiment, the side surface in the +Y direction of the recording apparatus 1 may not be the front surface of the recording apparatus 1. For example, the side surface in the +X direction of the recording apparatus 1 may be the front surface of the recording apparatus 1. In this case, the side surface 11f is the right side surface of the main body unit 11, the side surface 61f is the right side surface of the extension body 61, and the side surface 71f is the right side surface of the extension body 71. Alternatively, the side surface in the -X direction of the recording apparatus 1 may be the front surface of the recording apparatus 1. In this case, the side surface 11f is the left side surface of the main body unit 11, the side surface 61f is the left side surface of the extension body 61, and the side surface 71f is the left side surface of the extension body 71.

In the embodiment, the motors M25, M68, and M78 may not be provided in the cassettes 2, 62, and 72. For example, the motor M25 may be provided in the main body unit 11 to be capable of driving the driving roller 25 when the cassette 2 is attached to the main body unit 11. For example, the motor M68 may be provided in the extension body 61 to be capable of driving the driving roller 68 when the cassette 62 is attached to the extension body 61. For example, the motor M78 may be provided in the extension body 71 to be capable of driving the driving roller 78 when the cassette 72 is attached to the extension body 71.

In the embodiment, the separation rollers 6, 66, and 76 may not be provided in the cassettes 2, 62, and 72. In this case, the separation roller 6 may be provided in the main body unit 11 to be movable to above the cassette 2 when the cassette 2 is detached from the main body unit 11. In this case, the separation roller 66 may be provided in the extension body 61 to be movable to above the cassette 62 when the cassette 62 is detached from the extension body 61. In this case, the separation roller 76 may be provided in the extension body 71 to be movable to above the cassette 72 when the cassette 72 is detached from the extension body 71.

In the embodiment, the attachment section 52 and the section to be attached 612 may not be provided at the positions separated from the attachment section 51 and the section to be attached 611 in the -Y direction. For example, the attachment section 51 and the section to be attached 611 are provided at positions adjacent to the -Y direction side of the feeding path C62 and the relay roller pair 67. In this case, for example, the attachment section 51 and the section to be attached 611 are provided at the ends in the +X direction from the centers of the main body unit 11 and the extension body 61 in the X-axis direction.

In this case, for example, the attachment section 52 and the section to be attached 612 may be provided at positions separated from the attachment section 51 and the section to be attached 611 in the -X direction, the positions being the ends in the -X direction from the centers of the main body unit 11 and the extension body 61. In this case, the attachment section 613, the section to be attached 711, and the attachment section 713 are disposed at the same positions as the positions of the attachment section 51 and the section to be attached 611 in the X-axis direction and the Y-axis direction. In this case, the attachment section 614, the section to be attached 712, and the attachment section 714 are disposed at the same positions as the positions of the attachment section 52 and the section to be attached 612 in the X-axis direction and the Y-axis direction.

In the embodiment, the extension body 71 may be attachable to the extension body 61 and may not be attachable to the main body unit 11. In this case, for example, the attachment section 613 is formed in a shape different from the shape of the attachment section 51 and the section to be attached 711 fit in the attachment section 613 is formed in a shape different from the shape of the section to be attached 611 fit in the attachment section 51. Accordingly, when the recording apparatus 1 includes the extension bodies 61 and 71, the cassettes 2, 62, and 72 provided in the recording apparatus 1 are disposed in the order of the cassette 2, the cassette 62, and the cassette 72 from the top.

In the embodiment, a plurality of cassettes may be detachably provided in one extension body. For example, in one extension body, the extension body 71 may be attached to the extension body 61. In this case, one extension body includes, detachably from the +Y direction side, the cassette 62 in which the relay roller pair 67 and a part of the feeding path C62 are provided and the cassette 72 in which the relay roller pair 77 and a part of the feeding path C72 are provided.

What is claimed is:

1. A recording apparatus comprising:
a main body unit including a recording unit configured to perform recording on a medium;
a cassette detachably provided in the main body unit, the cassette including a storing unit configured to store the medium; and
a delivery roller configured to deliver the medium from the storing unit, wherein a conveyance roller located below the delivery roller is provided in the cassette, the conveyance roller conveying, toward the recording unit, the medium delivered from another cassette provided below the cassette.

2. The recording apparatus according to claim 1, wherein the other cassette is detachably provided in an extension body detachably attachable to the main body unit, and
the main body unit includes an attachment section to which the extension body is attached.

3. The recording apparatus according to claim 1, wherein the conveyance roller is provided at a position overlapping the storing unit when viewed from a front surface side of the main body unit.

4. The recording apparatus according to claim 1, wherein a motor that drives the conveyance roller is provided in the cassette.

5. The recording apparatus according to claim 1, wherein the cassette is detached from a front surface side of the main body unit.

6. The recording apparatus according to claim 5, wherein the cassette includes a cover on the front surface side of the storing unit, and
the conveyance roller is provided on the cover.

7. The recording apparatus according to claim 5, wherein the medium is conveyed toward the recording unit through the front surface side of the storing unit in the cassette.

8. An extension body attachable to a main body unit including a recording unit configured to perform recording on a medium, the extension body comprising:
a cassette detachably provided in the extension body, the cassette including a storing unit configured to store the medium; and
a delivery roller configured to deliver the medium from the storing unit, wherein a conveyance roller located below the delivery roller is provided in the cassette, the conveyance roller conveying, toward the recording unit, the medium delivered from another cassette provided below the cassette.
